(19) United States
(12) Patent Application Publication
(10) Pub. No.: US 2015/0154775 A1
(43) Pub. Date: Jun. 4, 2015

(54) DISPLAY CONTROL METHOD, INFORMATION PROCESSOR, AND COMPUTER PROGRAM PRODUCT

(71) Applicant: Kabushiki Kaisha Toshiba, Tokyo (JP)

(72) Inventors: Yoshikata TOBITA, Tokyo (JP); Tomoyuki HARADA, Tokyo (JP); Akinobu IGARASHI, Tokyo (JP); Tetsuya MASHIMO, Tokyo (JP)

(21) Appl. No.: 14/476,589

(22) Filed: Sep. 3, 2014

(30) Foreign Application Priority Data
Dec. 2, 2013 (JP) 2013-249663

(51) Int. Cl. G06T 11/60; G06K 9/62

(52) U.S. Cl. CPC G06T 11/60; G06K 9/6267

(57) ABSTRACT

According to one embodiment, method includes: classifying images into first group and second group, the first group comprising images, the second group comprising images, both the first group and the second group comprising first image; setting each of images in the first group to be either one of displayable or non-displayable; setting each of images in the second group to be either one of displayable or non-displayable; displaying first representative image of the first group, the first representative image being generated based on at least one displayable image in the first group; displaying second representative image of the second group, the second representative image being generated based on at least one displayable image in the second group; displaying, when the first representative image is selected, displayable images in the first group; and displaying, when the second representative image is selected, a plurality of displayable images in the second group.

### CROSS-REFERENCE TO RELATED APPLICATIONS

This application is based upon and claims the benefit of priority from Japanese Patent Application No. 2013-249663, filed Dec. 2, 2013, the entire contents of which are incorporated herein by reference.

### FIELD

Embodiments described herein relate generally to a display control method, information processor, and a computer program product.

### BACKGROUND

There has been disclosed a technique that detects face images (one example of an object) included in each of a plurality of images, classifies the images into a plurality of groups based on the degree of similarity of feature quantities of the detected face images, and determines, for each group, a representative image representing the group from among the face images included in the images classified into the corresponding group.

However, according to the conventional technique, there are cases in which a representative image generated using a face image included in an image prohibited from being displayed in the group is displayed. This results in displaying, as a representative image, an image that is not appropriate as a representative image representing the group.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view of an appearance of an information processor according to an embodiment;

FIG. 2 is an exemplary block diagram of a hardware configuration of the information processor in the embodiment;

FIG. 3 is an exemplary block diagram of a functional configuration of the information processor in the embodiment;

FIG. 4 is an exemplary diagram of a content data table stored in the information processor in the embodiment;

FIG. 5 is an exemplary diagram of an object data table stored in the information processor in the embodiment;

FIG. 6 is an exemplary diagram of a setup screen displayed by the information processor in the embodiment;

FIG. 7 is an exemplary flowchart illustrating a selection screen generating process performed by the information processor in the embodiment; and

FIG. 8 is an exemplary diagram of a selection screen displayed by the information processor in the embodiment.

### DETAILED DESCRIPTION

In general, according to one embodiment, a display control method comprises: classifying a plurality of images into a first group and a second group, the first group comprising a plurality of images, the second group comprising a plurality of images, both the first group and the second group comprising a first image; setting each of a plurality of images in the first group to be either one of displayable or non-displayable; setting each of a plurality of images in the second group to be either one of displayable or non-displayable; displaying a first representative image of the first group, the first representative image being generated based on at least one displayable image in the first group; displaying a second representative image of the second group, the second representative image being generated based on at least one displayable image in the second group; displaying, when the first representative image is selected, a plurality of displayable images in the first group; and displaying, when the second representative image is selected, a plurality of displayable images in the second group.

A display control method, an information processor, and a computer program according to an embodiment will be described below with reference to the accompanying drawings.

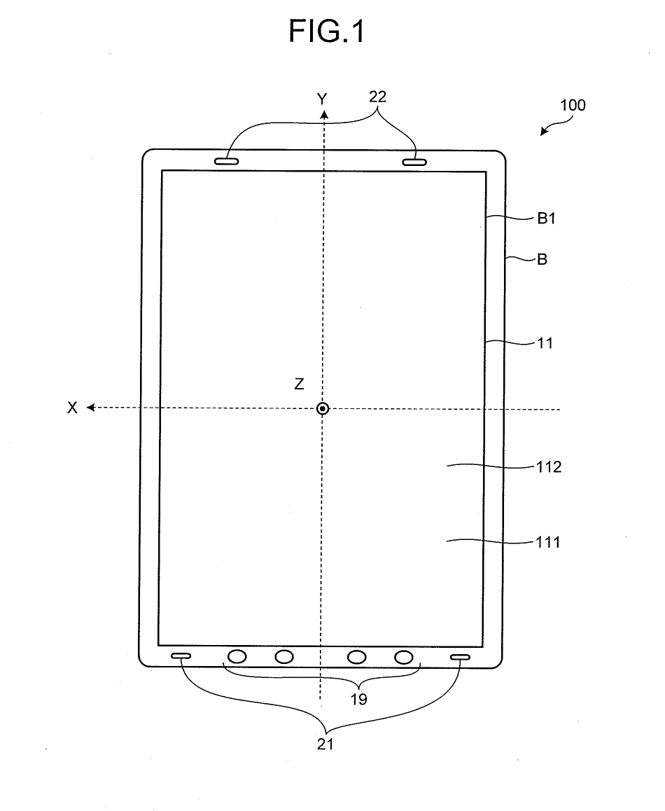

FIG. 1 is a schematic view of an appearance of the information processor according to the embodiment. This information processor 100 in the embodiment is achieved by, for example, a tablet terminal or a digital photo frame. Specifically, as illustrated in FIG. 1, the information processor 100 comprises a slate housing B. The housing B houses therein a display 11. In the embodiment, the housing B has a surface (hereinafter referred to as an upper surface) that has an opening B1 through which a display screen 112 of the display 11 is exposed.

The display 11 comprises: the display screen 112 that can display various types of information; and a touch panel 111 that detects a specific position on the display screen 112 touched by a user. In addition, the housing B comprises: operating switches 19 with which the user performs various types of operations; and microphones 21 for acquiring voice of the user at a lower portion of the upper surface. The housing B also comprises speakers 22 for outputting voice at an upper portion of the upper surface.

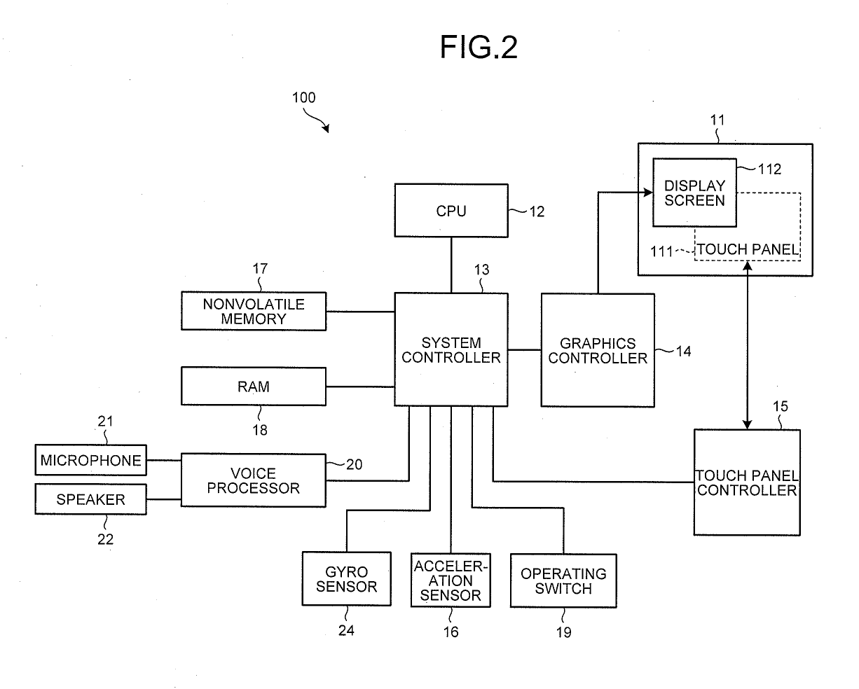

FIG. 2 is a block diagram illustrating an exemplary hardware configuration of the information processor according to the embodiment. In the embodiment, the information processor 100 comprises, as illustrated in FIG. 2, a central processing unit (CPU) 12, a system controller 13, a graphics controller 14, a touch panel controller 15, an acceleration sensor 16, a nonvolatile memory 17, a random access memory (RAM) 18, a voice processor 20, and a gyro sensor 24, in addition to the above-described configuration.

The display 11 comprises the touch panel 111 and the display screen 112 formed, for example, of a liquid crystal display (LCD) or an organic electro-luminescence (EL). The touch panel 111 is, for example, a coordinate detector disposed on the display screen 112. The touch panel 111 detects a specific position (touch position) on the display screen 112 touched by a finger of the user who holds the housing B.

The CPU 12 is a processor that controls each part and module of the information processor 100 via the system controller 13. The CPU 12 executes various types of application programs loaded from the nonvolatile memory 17 on the RAM 18, such as an operating system, a web browser, and software used for preparing text.

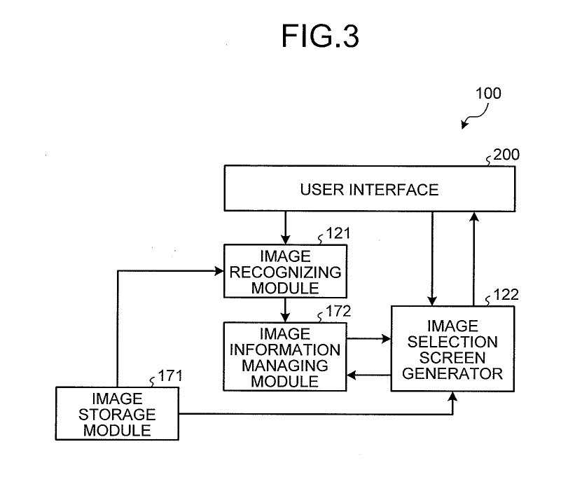

The nonvolatile memory 17 stores therein various types of application programs and data. In the embodiment, the nonvolatile memory 17 functions as an image storage module 171 (see FIG. 3) and an image information managing module 172 (see FIG. 3). Specifically, the image storage module 171 stores therein a plurality of images of display objects (display candidates) to be displayed on the display screen 112 (e.g., an acquired image acquired by a camera not illustrated of the information processor 100, an image input from an external device). The image information managing module 172 stores therein image information relating to images stored in the image storage module 171. The RAM 18 provides a work area to be used when the CPU 12 executes a computer program.

The system controller 13 has a built-in memory controller that controls access to the nonvolatile memory 17 and the RAM 18. Additionally, the system controller 13 has a function of performing communication with the graphics controller 14.

The graphics controller 14 serves as a display controller that controls the display screen 112. The touch panel controller 15 controls the touch panel 111 to thereby acquire from the touch panel 111 coordinate data indicating a touch position on the display screen 112 touched by the user.

The gyro sensor 24 detects the angle of rotation of the information processor 100 when the information processor 100 rotates about each of the X axis, the Y axis, and the Z axis. The gyro sensor 24 then outputs to the CPU 12 a rotating angle signal indicating the angle of rotation about each of the X axis, the Y axis, and the Z axis.

The acceleration sensor 16 detects acceleration of the information processor 100. In the embodiment, the acceleration sensor 16 detects acceleration in the axial direction of each of the X axis, the Y axis, and the Z axis illustrated in FIG. 1, and acceleration in the rotating direction about each of the X axis, the Y axis, and the Z axis. The acceleration sensor 16 then outputs to the CPU 12 an acceleration signal indicating the acceleration in the axial direction of each of the X axis, the Y axis, and the Z axis illustrated in FIG. 1, and acceleration in the rotating direction about each of the X axis, the Y axis, and the Z axis.

The voice processor 20 performs voice processing, such as digital conversion, noise removal, and echo cancelling, on voice signals input through the microphones 21, and outputs the processed signals to the CPU 12. Additionally, the voice processor 20 performs voice processing, such as voice synthesis, under the control of the CPU 12, and outputs a voice signal thus generated to the speakers 22.

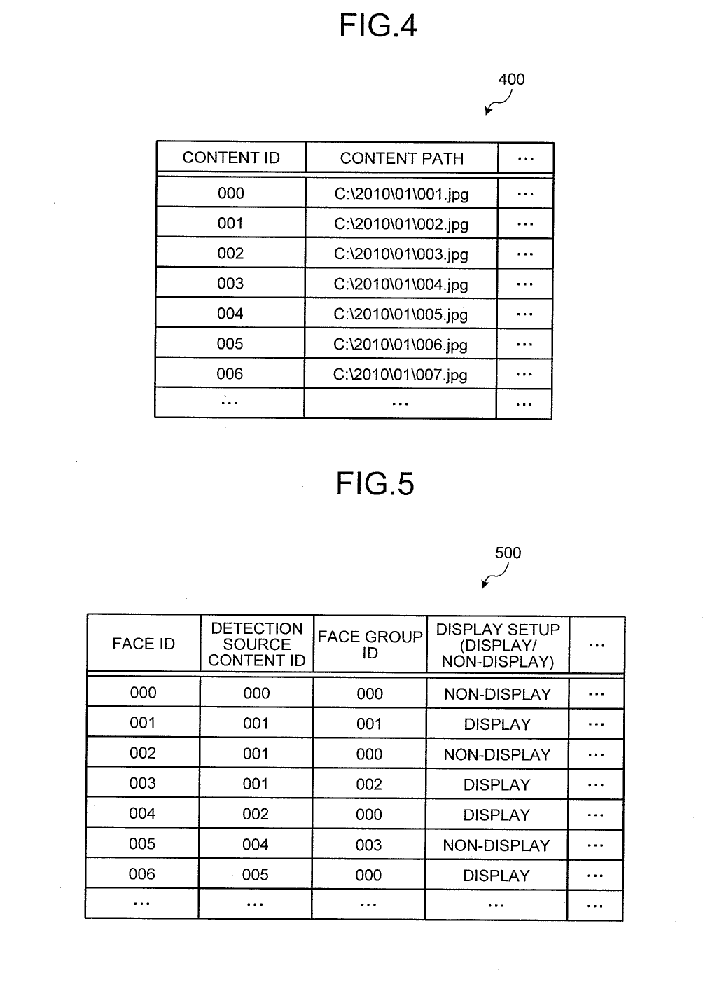

With reference to FIGS. 3 to 5, a functional configuration of the information processor 100 in the embodiment will be described below. FIG. 3 is a block diagram of the functional configuration of the information processor in the embodiment. FIG. 4 is a diagram of a content data table stored in the information processor in the embodiment. FIG. 5 is a diagram of an object data table stored in the information processor in the embodiment.

As illustrated in FIG. 3, in the information processor 100, the CPU 12 executes a computer program stored in the nonvolatile memory 17, which results in an image recognizing module 121 and an image selection screen generator 122 achieving respective functions. In the embodiment, the touch panel 111 functions as a user interface 200 that allows the user to input various types of operations to the information processor 100. The nonvolatile memory 17 functions as the image storage module 171 that stores therein images as display objects to be displayed on the display screen 112 and as the image information managing module 172 that stores therein image-related information relating to the images stored in the image storage module 171.

The image recognizing module 121, when instructed via the user interface 200 to recognize images (content) stored in the image storage module 171, stores a content data table 400 (see FIG. 4) as the image-related information in the image information managing module 172. The content data table 400 associates an content ID that enables identification of each of the images stored in the image storage module 171, a content path that indicates a specific location at which the image identified by the content ID is stored, and metadata of the image identified by the content ID (exemplary setup information set in advance for the image), with each other. In the embodiment, the metadata includes an image size, time and date at when the image is acquired from an external device, and, for an acquired image acquired by a camera not illustrated, imaging conditions (e.g., site at which the acquired image is acquired, time and date of image acquisition, a person who acquired the acquired image).

The image recognizing module 121 then classifies images identified by respective content IDs of the content data table 400 into one or a plurality of groups. At this time, the image recognizing module 121 (an one example of classifying module) can classify the same image into a plurality of groups. Specifically, the image recognizing module 121 can classify a plurality of images into: a group (a first group) comprising a first image and at least one of other images; and a group (a second group) comprising the first image and at least one of other images. It is here noted that the first image may be two or more images included in the plurality of images. In the embodiment, the image recognizing module 121 first detects objects (object images) from the images identified by the content IDs of the content data table 400. For example, if the images identified by the content IDs of the content data table 400 are acquired images acquired by a camera not illustrated, the image recognizing module 121 detects acquired subjects acquired by the camera not illustrated (e.g., face images) as the objects.

Based on the objects detected from the image, the image recognizing module 121 can classify the images into the first group and the second group. Specifically, for each of the objects detected from the image, the image recognizing module 121 classifies images that include objects similar to the specific object in question into one group. Thus, the image recognizing module 121, if detecting a plurality of objects from the same image (the first image), classifies the image into each of groups of the objects. This allows the image recognizing module 121 to classify the same image into both the first group and the second group. The embodiment has been described for a case in which the image recognizing module 121 classifies the images into the first group and the second group, each group including the same image (the first image) and at least one of other images. This is, however, not the only possible arrangement, as long as the image recognizing module 121 classifies a plurality of images into two or more groups, each group including the same image and at least one of other images. For example, the image recognizing module 121 may classify a plurality of images into three groups, each group including the same image (the first image) and at least one of other images.

In the embodiment, the image recognizing module 121 classifies a plurality of images into a plurality of groups (e.g., the first group and the second group) based on the objects included in the images. This is, however, not the only possible arrangement; alternatively, the image recognizing module 121 may classify a plurality of images into a plurality of groups based on the metadata of the image or image setup information to be described later.

For each of the groups (e.g., the first group and the second group) comprising the same image (the first image), the image recognizing module 121 (an exemplary setting module) sets at least one of the images comprised in the each group so that the at least one of the images comprised in the each group is permitted to be displayed on the display 11 (the display screen 112). The image permitted to be displayed on the display 11 will hereinafter be referred to as a display image. Additionally, for each of the groups (e.g., the first group and the second group) comprising the same image (the first image), the image recognizing module 121 can sets at least one (the first image) of the images comprised in the each group so that the at least one of the images is prohibited from being displayed on the display 11. In the embodiment, of the images included in each group, the image recognizing module 121 sets images that are not the display images so that those images are prohibited from being displayed on the display 11.

The image recognizing module 121 stores an object data table 500 as the image-related information in the image information managing module 172. As illustrated in FIG. 5, the object data table 500 associates a face ID, a content ID, a face group ID, and the image setup information (one example of setup information), with each other. Specifically, the face ID enables identification of an object (e.g., a face image) detected from the image. The content ID indicates the image (content) in which the object identified by the face ID is detected (hereinafter referred to as a detection source content ID). The face group ID enables identification of the group into which the image identified by the detection source content ID is classified. The image setup information is set in advance for the image identified by the detection source content ID.

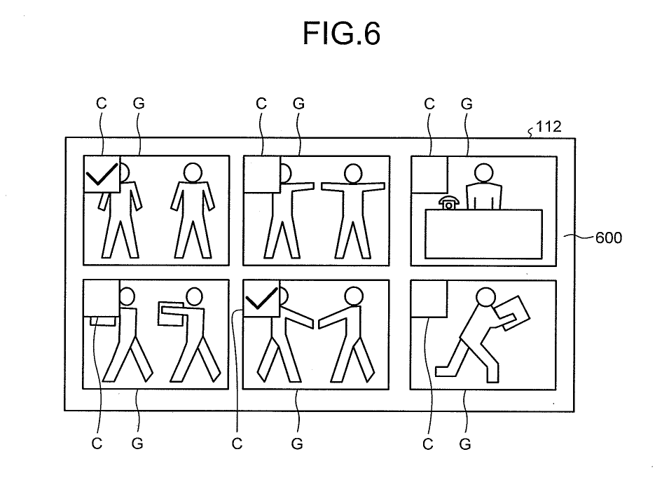

In the embodiment, the image setup information includes: a display setup indicating whether an image identified by the detection source content ID is set to be a display image in the group into which the image is classified (“display” if displaying of the image is set to be permitted or “non-display” if displaying of the image is set to be prohibited); the shade of the image; the sharpness of the image; the scene of the image; the season in which the image is acquired, object information indicating objects included in the image (e.g., face image, plant or animal, building, logo mark); and sex, age, and level of smile of a person (an exemplary object) included in the image. In the embodiment, in an initial state in which a plurality of images are classified into a plurality of groups, or to state the foregoing differently, before the display setup is changed through a setup screen 600 (see FIG. 6) to be described later, the image recognizing module 121 sets the display setup included in the image setup information to “display”.

The image selection screen generator 122, when instructed via the user interface 200 to change the display setup of the images included in each group, displays, for each group, on the display screen 112 of the display 11 the setup screen through which the display setup of the images included in the group can be changed.

FIG. 6 is an exemplary setup screen displayed by the information processor in the embodiment. When it is instructed via the user interface 200 to change the display setup of the images included in each group, the image selection screen generator 122 displays, for each group and on the display screen 112, the setup screen 600 in which images G included in each group are positioned. Here, the setup screen 600 includes check boxes C that allow the display setup for the images G to be changed. The user of the information processor 100 selects or deselects the check box C of each of the images G through the user interface 200.

In the group into which the images G displayed on the setup screen 600 are classified, out of those images G, for specific images G with selected check boxes C, the above-described image recognizing module 121 changes the display setup included in the image setup information to “display”. Similarly, in the group into which the images G displayed on the setup screen 600 are classified, out of those images G, for specific images G with deselected check boxes C, the image recognizing module 121 changes the display setup included in the image setup information to “non-display”. This allows the image recognizing module 121 to, as illustrated in FIG. 5, vary each individual display setup associated with the same detection source content ID for each face group ID (e.g., “001”, “000”, “002”, “003”).

For each of a plurality of groups (e.g., the first group and the second group) each including the same image (the first image), the image selection screen generator 122 generates and displays on the display 11 a representative image that represents a group (e.g., a first representative image representing the first group, a second representative image representing the second group) based on at least one of images (display images) included in the group and set to be permitted to be displayed. This enables the representative image to be generated based on an image (a display image) more appropriate for representing a group for the following reason. Specifically, even when the display setup of an image is set to “non-display” in any one group out of a plurality of groups, the representative image can be generated based on that particular image as long as the display setup of that particular image in another group is set to “display”. In addition, the image selection screen generator 122 generates and displays on the display 11 the representative image based on, for each of the plurality of groups each including the same image, images excluding at least one of images included in the group and prohibited from being displayed (images having the display setup set to “non-display”). This is to be specifically described as follows. Assume a case in which at least one image (the first image) included in the first group is prohibited from being displayed, while the first image classified into and included in the second group is set to be permitted to be displayed. In this case, the image selection screen generator 122 generates a representative image based on at least one of images of the first group excluding the first image, and generates a representative image based on at least one of images of the second group including the first image.

In the embodiment, when it is instructed via the user interface 200 to generate a selection screen that includes a representative image of each of a plurality of groups, the image selection screen generator 122 uses the content data table 400 and the object data table 500 stored in the image information managing module 172 to generate and display on the display screen 112 the selection screen that includes the representative image of each group.

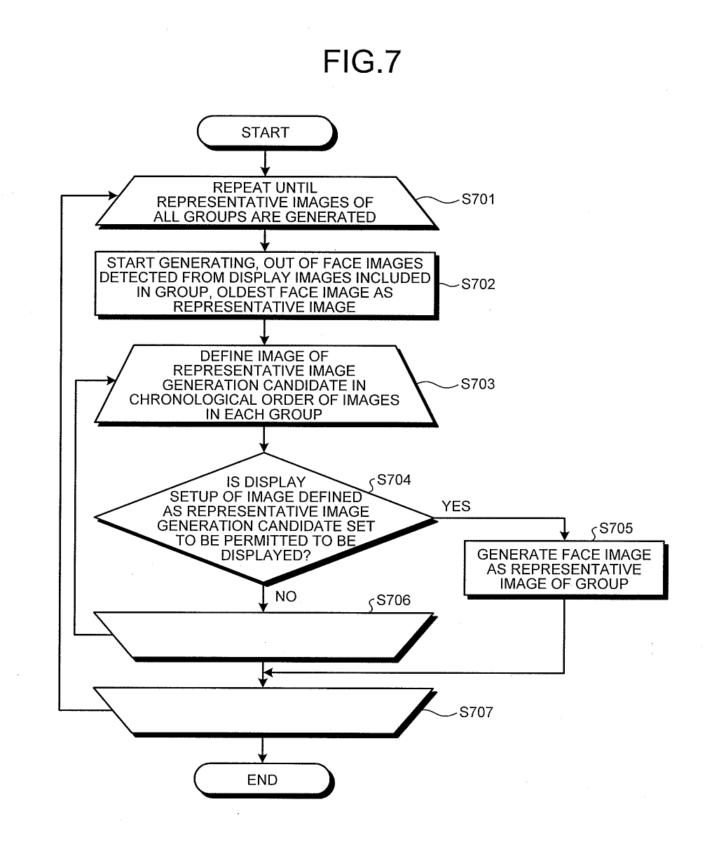

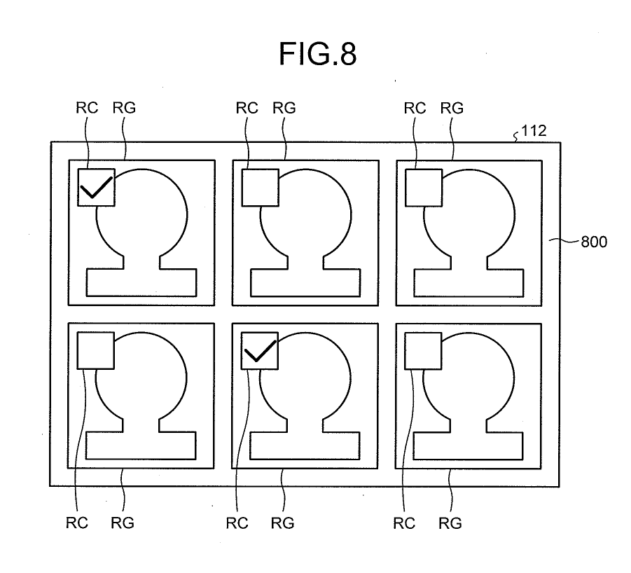

A selection screen display process performed by the information processor 100 in the embodiment will be described in detail below with reference to FIGS. 7 and 8. FIG. 7 is a flowchart illustrating a selection screen generating process performed by the information processor in the embodiment. FIG. 8 is an exemplary selection screen displayed by the information processor in the embodiment.

When it is instructed via the user interface 200 to generate a selection screen, the image selection screen generator 122 repeatedly performs the following steps for each group until the representative images of all groups are generated (S701). The image selection screen generator 122 starts generating, out of face images (exemplary objects) detected from display images included in the group for which the representative image is to be generated (hereinafter referred to as a group of interest), the oldest face image (a face image detected from a display image having the oldest time and date of image capturing) as a representative image (S702).

In the embodiment, when it is instructed via the user interface 200 to generate a selection screen, the image selection screen generator 122 performs generating a representative image for each group. This is, however, not the only possible arrangement. Alternatively, for example, if the image recognizing module 121 changes the display setup for at least one of a plurality of images included in a group, the image selection screen generator 122 may perform generating a representative image again. This allows a representative image to be regenerated based on the display images which the user finds appropriate in such a case in which an acquired image that assumes the representative image of each group changes over time, for example, and the object (e.g., a face image) used as the representative image is no longer appropriate.

The image selection screen generator 122 defines an image selected from among the images included in the group of interest as the image of a representative image generation candidate in chronological order of the time and date of image acquiring included in the metadata associated with the content ID in the content data table 400 (S703).

Specifically, the image selection screen generator 122 first identifies the face ID associated with the face group ID in the group of interest in the object data table 500. The image selection screen generator 122 next identifies the detection source content ID associated with the identified face ID in the object data table 500. Furthermore, the image selection screen generator 122 defines an image as the image of a representative image generation candidate in order of images identified by, of the detection source content IDs (content IDs), the detection source content IDs (content IDs) associated with old times and dates of image capturing (metadata) in the content data table 400.

Then, the image selection screen generator 122 determines, in the object data table 500, whether the display setup associated with the detection source content ID of the image defined as the representative image generation candidate is set to “display” (S704). When it is determined that the display setup associated with the detection source content ID of the image defined as the representative image generation candidate is set to “display” (Yes at S704), the image selection screen generator 122 generates as the representative image the face image identified by the face ID associated with the detection source content ID of the image defined as the representative image generation candidate in the object data table 500 (S705).

Conversely, if it determines that the display setup associated with the detection source content ID of the image defined as the representative image generation candidate is set to “non-display” (No at S704), the image selection screen generator 122 performs S707, and completes the determination at S704 for all images included in the group of interest.

If the display setups stored in association with the detection source content IDs of all images included in the group of interest are set to “non-display” (all images included in the group of interest are prohibited from being displayed), the image selection screen generator 122 generates a representative image based on at least one of images included in the group of interest and prohibited from being displayed. For example, the image selection screen generator 122 may generate as the representative image an object included in any one of a plurality of images included in the group of interest. Alternatively, the image selection screen generator 122 may generate as the representative image an image that includes an object included in each of the plurality of images included in the group of interest. This avoids a case in which no representative images are generated, so that the representative image can be reliably generated even when the display setups stored in association with the detection source content IDs of all images included in the group of interest are set to “non-display”.

If a determination is yet to be made at S704 for all images included in the group of interest (S706), the image selection screen generator 122 returns to S703 and defines as the image of the representative image generation candidate an image selected from among the images included in the group of interest, the image having the second oldest time and date of image acquiring included in the metadata associated with the content ID in the content data table 400.

If the representative images of all groups are generated, the image selection screen generator 122 terminates the generation of the representative images. If the representative images of all groups are not yet generated, the image selection screen generator 122 returns to S701 (S707).

When the representative images of a plurality of groups are generated, the image selection screen generator 122 displays on the display screen 112 of the display 11 a selection screen in which the representative images of the respective groups are positioned. In the embodiment, as illustrated in FIG. 8, the image selection screen generator 122 displays on the display screen 112 a selection screen 800 in which representative images RG of respective groups are positioned. Here, the selection screen 800 includes check boxes RC that indicate whether a display image is included in the plurality of images included in each group.

If at least one display image is included in the images included in the group corresponding to the representative image RG, the image selection screen generator 122 selects the check box RC of that particular representative image RG. If no display images are included in the images included in the group corresponding to the representative image RG, the image selection screen generator 122 deselects the check box RC of that particular representative image RG.

When the check box RC of the representative image RG is changed from its selected state to its deselected state through the user interface 200, the image recognizing module 121 changes to “non-display” in the object data table the display setups associated with the detection source content IDs of all images included in the group associated with the representative image RG having the check box RC changed to its deselected state. Conversely, when the check box RC of the representative image RG is changed from its deselected state to its selected state through the user interface 200, the image recognizing module 121 changes to “display” in the object data table the display setups associated with the detection source content IDs of all images included in the group associated with the representative image RG having the check box RC changed to its selected state.

In the embodiment, the image selection screen generator 122 selects the check box RC of the representative image RG associated with the group into which the display image is classified out of the representative images RG positioned in the selection screen 800, thereby allowing the group that includes the display image to be distinguished from the group that does not include the display image. This is, however, not the only possible arrangement. Alternatively, the image selection screen generator 122 may, for example, cause the representative image RG of the group that does not include the display image to disappear or appear dimmed. Thereby, the image selection screen generator 122 differentiate a display mode between the group that includes the display image and the group that does not include the display image, thereby allowing the group that includes the display image to be distinguished from the group that does not include the display image.

When a representative image associated with the group that includes the display image (in FIG. 8, the representative images RG having their check boxes RC selected) out of the representative images disposed in the selection screen displayed on the display screen 112 is selected through the user interface 200, the image selection screen generator 122 displays an image (display image) included in the group associated with the selected representative image on the display screen 112 of the display 11. At this time, the image selection screen generator 122 displays on the display screen 112 an image excluding at least one of images of the group associated with the selected representative image and prohibited from being displayed (images having the display setups set to “non-display”).

Specifically, if the first representative image is selected from among the representative images (the first representative image and the second representative image) of the respective groups (the first group and the second group) that include the same image (the first image), the image selection screen generator 122 displays at least one of images included in the first group and permitted to be displayed. If the second representative image is selected, the image selection screen generator 122 displays at least one of images included in the second group and permitted to be displayed. Alternatively, if the first representative image is selected, the image selection screen generator 122 displays the image excluding at least one of images included in the first group and prohibited from being displayed. If the second representative image is selected, the image selection screen generator 122 displays the image excluding at least one of images included in the second group and prohibited from being displayed. This allows the user of the information processor 100 to view, for each group, only the display image out of the images included in the group.

In the embodiment, the image selection screen generator 122 generates the object (e.g., a face image) included in the display image included in the group as the representative image of the group. This is, however, not the only possible arrangement, as long as the image selection screen generator 122 displays a representative image generated based on at least one of images included in the group and permitted to be displayed. For example, the image selection screen generator 122 may generate and display as the representative image one entire display image out of a plurality of display images included in the group or an image that includes a plurality of display images included in each group.

As described above, the information processor 100 in the embodiment allows an object included in an image having the display setup set to “non-display” in any one of a plurality of groups to be generated as the representative image in another group. This enables the representative image to be generated based on an image (display image) more appropriate as the image representing the group.

Additionally, the image selection screen generator 122 in the embodiment generates as the representative image the oldest face image out of the face images detected from the display image included in the group. The image selection screen generator 122 may nonetheless generate as the representative image an object that complies with a certain selection condition out of the objects included in the display image included in the group.

Specifically, the image selection screen generator 122 uses the setup information set in advance for the display image (e.g., the metadata of the content data table 400, the image setup information of the object data table 500) to generate as the representative image the object that complies with the predetermined selection out of the objects included in one or more display images included in the group and permitted to be displayed. For example, the image selection screen generator 122 generates as the representative image an object included in the display image having the highest level of smile or sharpness included in the image setup information of the object data table 500, of all the objects included in one or more display images included in the group and permitted to be displayed. This enables an object that is readily identifiable by the user to be defined as the representative image.

The computer program executed by the information processor 100 in the embodiment is recorded and provided in a computer-readable recording medium such as a compact disc read only memory (CD-ROM), a flexible disk (FD), a compact disc recordable (CD-R), and a digital versatile disc (DVD), as an installable or executable file.

The computer program executed by the information processor 100 in the embodiment may be stored in a computer connected to a network such as the Internet and provided by being downloaded via the network. Furthermore, the computer program executed by the information processor 100 in the embodiment may be provided or distributed via a network such as the Internet.

The computer program executed by the information processor 100 in the embodiment has a modular configuration comprising the above-described functional units (the image recognizing module 121 and the image selection screen generator 122). Each functional unit is generated as actual hardware of the image recognizing module 121 and the image selection screen generator 122 on a main storage as a result of the CPU (processor) loading the computer program from the storage medium and executing the loaded program.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control method comprising:
classifying a plurality of images into a first group and a second group, the first group comprising a plurality of images, the second group comprising a plurality of images, both the first group and the second group comprising a first image;
setting each of a plurality of images in the first group to be either one of displayable or non-displayable;
setting each of a plurality of images in the second group to be either one of displayable or non-displayable;
displaying a first representative image of the first group, the first representative image being generated based on at least one displayable image in the first group;
displaying a second representative image of the second group, the second representative image being generated based on at least one displayable image in the second group;
displaying, when the first representative image is selected, a plurality of displayable images in the first group; and
displaying, when the second representative image is selected, a plurality of displayable images in the second group.

2. The display control method of claim 1, wherein,
when the first image in the first group is set to be non-displayable and when the first image in the second group is set to be displayable, the first representative image is generated based on the at least one displayable image in the first group, excluding the first image, and the second representative image is generated based on the at least one displayable image in the second group, including the first image,
when the first representative image is selected, the displayable images in the first group, excluding the first image, is displayed, and
when the second representative image is selected, the displayable images in the second group, including the first image, is displayed.

3. The display control method of claim 1, wherein the plurality of images are classified into the groups comprising the first group and the second group based on objects in the plurality of images.

4. The display control method of claim 1, wherein
the displaying of the first representative image comprises displaying the first representative image generated based on first objects in the at least one displayable image in the first group; and
the displaying of the second representative image comprises displaying the second representative image generated based on second objects in the at least one displayable image in the second group.

5. The display control method of claim 1, further comprising:
regenerating, when a setting of the displayable image in the first group is changed, the first representative image, and displaying the regenerated first representative image; and
regenerating, when a setting of the displayable image in the second group is changed, the second representative image, and displaying the regenerated second representative image.

6. The display control method of claim 2, wherein
the displaying of the first representative image comprises displaying, when all of the images in the first group are set to be non-displayable, the first representative image generated based on the images in the first group; and
the displaying of the second representative image comprises displaying, when all of the images in the second group are set so to be non-displayable, the first representative image generated based on the images in the second group.

7. The display control method of claim 4, wherein
the displaying of the first representative image comprises displaying, from among the first objects, an object that satisfies a first selection condition as the first representative image, and
the displaying of the second representative image comprises displaying, from among the second objects, an object that satisfies a second selection condition as the second representative image.

8. The display control method of claim 4, wherein
the displaying of the first representative image comprises displaying a face image, which is an object in the displayable image in the first group, as the first representative image, and
the displaying of the second representative image comprises displaying a face image, which is an object in the displayable image in the second group, as the second representative image.

9. An information processor comprising:
a classifying controller configured to classify a plurality of images into a first group and a second group, the first group comprising a plurality of images, the second group comprising a plurality of images, both the first group and the second group comprising a first image;
a setting controller configured to set each of a plurality of images in the first group to be either one of displayable or non-displayable, and to set each of a plurality of images in the second group to be either one of displayable or non-displayable;
a display controller, wherein
the display controller is configured to display a first representative image of the first group, the first representative image being generated based on at least one displayable image in the first group,
the display controller is configured to display a second representative image of the first group, the second representative image being generated based on at least one displayable image in the second group,
the display controller is configured to display, when the first representative image is selected, a plurality of displayable images in the first group, and
the display controller is configured to display, when the second representative image is selected, a plurality of displayable images in the second group.

10. The information processor of claim 9, wherein,
when the first image in the first group is set so as to prohibit the first image in the first group from being displayed and when the first image in the second group is set so as to permit the first image in the second group to be displayed, the display controller is configured to generate the first representative image based on the at least one displayable image in the first group excluding the first image, and to generate the second representative image based on the at least one displayable image in the second group,
when the first representative image is selected, the display controller is configured to display the displayable images in the first group excluding the first image, and
when the second representative image is selected, the display controller is configured to display the displayable images in the second group.

11. The information processor of claim 9, wherein
the display controller is configured to display the first representative image generated based on first objects in the at least one displayable image in the first group; and
the display controller is configured to display the second representative image configured to be generated based on second objects in the at least one displayable image in the second group.

12. The information processor of claim 9, wherein
the display controller is configured to regenerate, when a setting of the displayable image in the first group is changed, and to display the regenerated first representative image; and
the display controller is configured to regenerate, when a setting of the displayable image in the second group is changed, the second representative image, and to display the regenerated second representative image.

13. A computer program product having a non-transitory computer readable medium including programmed instructions, wherein the instructions, when executed by a computer, cause the computer to perform:
classifying a plurality of images into a first group and a second group, the first group comprising a plurality of images, the second group comprising a plurality of images, both the first group and the second group comprising a first image;
setting each of a plurality of images in the first group to be either one of displayable or non-displayable;
setting each of a plurality of images in the second group to be either one of displayable or non-displayable;
displaying a first representative image of the first group, the first representative image being generated based on at least one displayable image in the first group;
displaying a second representative image of the second group, the second representative image being generated based on at least one displayable image in the second group;
displaying, when the first representative image is selected, a plurality of displayable images in the first group; and
displaying, when the second representative image is selected, a plurality of displayable images in the second group.

14. The computer program product of claim 13, wherein
when the first image in the first group is prohibited from being displayed and when the first image in the second group is permitted to be displayed, the first representative image is generated based on the at least one displayable image in the first group excluding the first image, and the second representative image is generated based on the at least one displayable image in the second group including the first image,
when the first representative image is selected, the displayable images in the first group excluding the first image is displayed, and
when the second representative image is selected, the displayable images in the second group including the first image is displayed.

15. The computer program product of claim 13, wherein
the displaying of the first representative image comprises displaying the first representative image generated based on first objects in the at least one displayable image in the first group; and
the displaying of the second representative image comprises displaying the second representative image configured to be generated based on second objects in the at least one displayable image in the second group.

16. The computer program product of claim 13, wherein
regenerating, when a setting of the displayable image in the first group is changed, the first representative image, and displaying the regenerated first representative image; and
regenerating, when a setting of the displayable image in the second group is changed, the second representative image, and displaying the regenerated second representative image.
